(19) United States
(12) Patent Application Publication
(10) Pub. No.: US 2026/0079261 A1
(43) Pub. Date: Mar. 19, 2026

(54) GNSS LOCATION AND VEHICLE OPERATION

(71) Applicant: Ford Global Technologies, LLC, Dearborn, MI (US)

(72) Inventors: Sharnam Shah, San Francisco, CA (US); Ganesh Kumar, Santa Clara, CA (US); Subodh Mishra, Bryan, TX (US); Md Nahid Pervez, San Jose, CA (US); Nalin Bendapudi, Ann Arbor, MI (US); Ankit Girish Vora, Northville, MI (US)

(73) Assignee: Ford Global Technologies, LLC, Dearborn, MI (US)

(21) Appl. No.: 18/885,797

(22) Filed: Sep. 16, 2024

(51) Int. Cl. G01S 19/23; G01S 19/21; G01S 19/42

(52) U.S. Cl. CPC G01S 19/23; G01S 19/21; G01S 19/42

(57) ABSTRACT

A computer that includes a processor and a memory, the memory including instructions executable by the processor to input real world coordinates of a real world location and a real world time, number and orbit data of GNSS satellites, terrain model data, and atmospheric model data to a first machine learning model to generate a simulated GNSS location and heading based on the real world location and a simulated GNSS error in location and heading in the real world coordinates. The first machine learning model can be trained based on an acquired GNSS location, an acquired GNSS time, an acquired number and orbit data of the GNSS satellites, an acquired GNSS DOP from real world systems, the terrain model data, and the atmospheric model data. Simulated GNSS data including the simulated GNSS location and heading can be generated to perform one or more of training and testing of a simulated vehicle operation system.

### BACKGROUND

Computers can operate systems and devices including vehicles, robots, drones, and/or object tracking systems. Global Navigation Satellite System (GNSS) data can be acquired by a system or device to determine a location and orientation of the system in an environment. Data including images can be acquired by sensors and processed by a computer and combined with the GNSS data to determine a trajectory for a system with respect to an environment.

### BRIEF DESCRIPTION OF THE DRAWINGS

FIG. 1 is a block diagram of an example vehicle system.

FIG. 2 is a diagram of an example vehicle including sensors.

FIG. 3 is a diagram of an example global navigation satellite system (GNSS).

FIG. 4 is a diagram of an example machine learning training system.

FIG. 5 is a diagram of an example GNSS simulation system.

FIG. 6 is a diagram of example of simulated vehicle operation system training and testing.

FIG. 7 is a flowchart diagram of a system to train and test a simulated vehicle operation system.

### DETAILED DESCRIPTION

Systems that move and/or that have mobile components, including vehicles, robots, drones, cell phones etc., can be operated by acquiring sensor data, including data regarding an environment around the system, and processing the sensor data to determine locations of objects in the environment around the system. The locations of objects in the environment can be combined with global navigation satellite system (GNSS) data to determine a trajectory for moving the system in the real world. Examples of GNSSs include the Global Positioning System (GPS) (U.S.), GLObal Navigation Satellite System (GLONASS) (Russia), Galileo (E.U.), and BeiDou (China). Vehicle operation will be used as an example of mobile system operation based on sensor data and GNSS data herein without loss of generality.

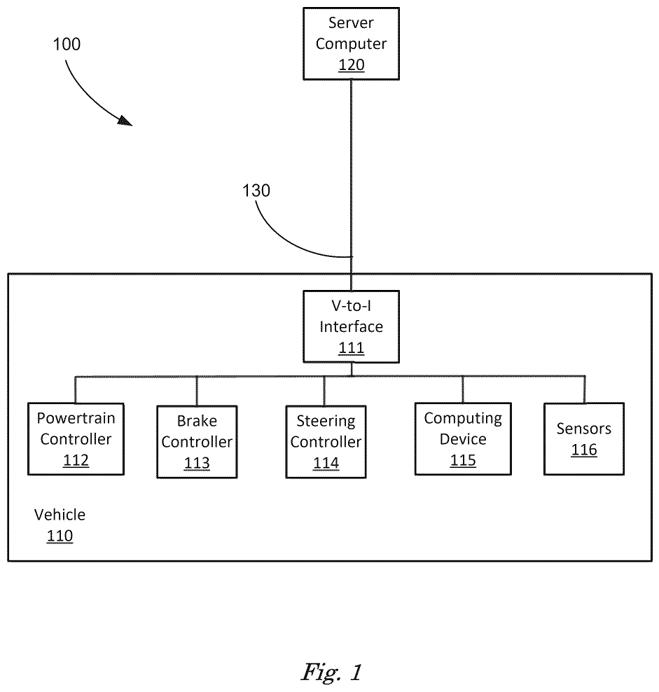

A machine learning system can be trained and installed in a computing device in a vehicle to receive sensor data from sensors included in the vehicle. The machine learning system can determine predictions regarding the received sensor data to assist in operating the vehicle. For example, a machine learning system can be trained to receive images from video cameras and/or lidar sensors and determine a predicted state for the vehicle. A predicted state output from the machine learning system can include predicted distances between the vehicle and objects, including other vehicles, in the environment. The object predictions can be combined with GNSS data received sensors included in the vehicle and used by the computing device to determine a trajectory that the vehicle could travel on to reach a predicted future location. The computing device can then direct the vehicle to travel on the trajectory by issuing commands to controllers which operate vehicle components as described below in relation to FIG. 1.

Operating a vehicle based on receiving vehicle sensor data at vehicle operating software included in a vehicle computing device can benefit from extensive training and testing prior to, and in parallel with, releasing the vehicle into general use. Training and testing vehicle operating software can be enhanced by performing the training and testing using computer simulations of environments around the vehicle included in a server computer. Computer simulations can be generated using photorealistic rendering software such as Unreal Engine. Unreal Engine is provided by Epic Games, Inc., Cary, NC, 27518. Simulations can generate vehicle sensor data that can simulate the field of view and magnification of video cameras and lidar sensors to generate video images and lidar images that include locations and identities of objects such as roadways and other vehicles. The determined locations and identities of objects in the simulated video images and lidar images can be used by vehicle operating software to train and test the vehicle operating software.

Simulation software can generate simulated sensor data based on map data that simulate video images and lidar images based on real world locations. The simulated sensor data can include realistic renderings of objects such as vehicles, roadways, buildings, and foliage that simulate the appearance of real world environments. Training and testing vehicle operating software can include determining locations of objects with respect to a simulated vehicle and the location of the simulated vehicle with respect to the simulated environment. Simulated sensor data includes the locations of the sensors and objects with respect to the environment because it is generated from mathematical descriptions of the scene to be generated. This data regarding locations of sensors and objects in real world coordinates can be used as simulated GNSS data to train machine learning models used in vehicle operation software.

In real world vehicle sensor systems this type of location data is not available prior to processing the sensor data. In real world operation, vehicle computing devices can use GNSS data, including a GNSS location, to establish a first estimate of vehicle location in x, y, and z real world coordinates. Operating a vehicle based on GNSS data and sensor data can depend upon reducing GNSS errors based on using map data and vehicle sensor data to reduce GNSS error in a subsequent estimate to less than one meter in the x, y, and z coordinates, for example.

As described above, even when operating optimally, GNSS data can have a random location error of three to five meters. In addition, factors such as number of visible satellites, geometric distribution of satellites, atmospheric conditions, and terrain can increase GNSS errors from three to five meters to 10 to 30 meters or more. The number and distribution of satellites visible from a given location can be summarized as dilution of precision (DOP). DOP can be determined as a function of the 4-dimensional vector positions (x, y, z, t) in space and time of the visible satellites with respect to the vector position of the receiver. DOP can range from <1 (excellent) to >20 (unusable), for example. The higher the DOP, the greater the GNSS error included in a GNSS location. DOP is deterministic because given a real world location and a time, the locations of GNSS satellites can be calculated.

Atmospheric conditions that influence GNSS errors include ionospheric delay. Charge particles in the ionosphere can cause the GNSS signals from a satellite to delay or refract, both of which can affect the accuracy of a GNSS location. Ionospheric conditions change slowly and are generally monitored and recorded on a continuous basis. Given a time and real world location, the effect of ionospheric conditions on GNSS satellite signals can be determined and GNSS error due to atmospheric conditions predicted.

Terrain, including man-made objects such as buildings and bridges can cause reflections that can cause multiple signals to be received via multiple paths at different times resulting multipath errors. A multipath error causes a single GNSS signal from a satellite to be received by a receiver with more than one delay times, causing GNSS errors by confusing the receiver. Terrain can also block satellite signals completely or partially, increasing DOP errors. Because terrain is generally fixed, GNSS terrain errors can be estimated for a given real world location based on a three-dimensional terrain model such as a relief map.

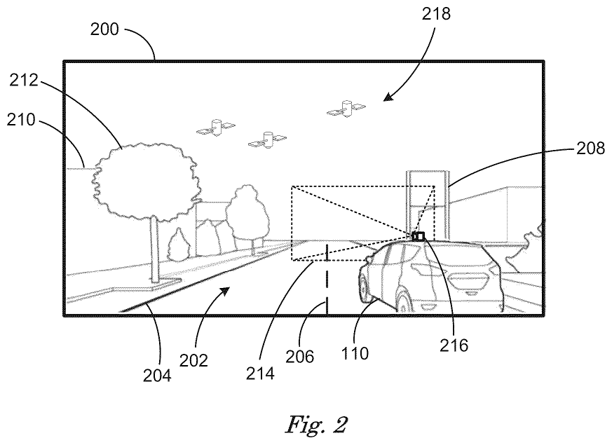

Based on the first estimate of vehicle location based GNSS data, vehicle location software can refine a GNSS based first estimate of vehicle location based on high-definition (HD) map data and acquired sensor data. HD map data is mapping data that includes features with a resolution of less than one meter, for example 10 centimeters or less. Features are defined as local structures such as edges or corners, for example, that can be determined based on pixel data included in HD map, video images, and lidar images. An example of a feature detector for image data is a features from accelerated segment test (FAST). FAST was documented in “Machine Learning for High-speed Corner Detection” Rosten, Edward and Drummond, Tom, Computer Vision-ECCV 2006, Lecture Notes in Computer Science. Vol. 3951. pp. 430-443. Features determined in video images and lidar images can be correlated with features determined in HD map data to enhance real world location determination from the first estimate of vehicle location based on GNSS data to a location estimate with a resolution of less than one meter in x, y, and z. Techniques for correlating real world features with HD map data are described below in relation to FIG. 2, below.

Success in training and testing machine learning models can be determined by comparing results from real world testing with results from simulation testing. When real world testing gets the same results as a simulation of the same real world location under the same weather and lighting conditions, the simulation training and testing can be regarded as successful. Simulation training and testing can be enhanced by making the simulation video images and lidar images as realistic as possible. Realism can be determined by comparing simulated images with real world images, either by comparing pixel values or by human observation. In the same way, simulating GNSS location data can provide an data for training and testing software a machine learning model.

Techniques described herein can train a machine learning model to output a simulated GNSS location based on a selected real world location, an selected GNSS time, a number and orbit data of GNSS satellites, an acquired GNSS DOP, and terrain model data at the selected time and location. Simulating GNSS data can enhance training and testing a machine learning model using simulated data by providing a more realistic simulation. Techniques described herein train a machine learning model to generate GNSS error data based on the real world location of the simulated image data and the real world time at which the simulated sensor data was generated. For example, if the simulated sensor data was simulating a vehicle traveling at a given location on a given date, at a given time of day, the trained machine learning model could determine the locations of visible GNSS satellites and, based on the satellite locations, the atmospheric conditions at that time and the terrain, predict the GNSS error in x, y, and z for that location and time.

A machine learning model may be employed to determine a location for a vehicle with greater than one meter accuracy in order to generate a trajectory for vehicle operation. As discussed above, a machine learning model can start with raw GNSS location data including GNSS errors. Without simulating GNSS errors, which can vary based on location and time, training and testing a machine learning model using simulations can result in biased results, which cannot be reproduced in the real world using real world GNSS data. Techniques for simulating GNSS errors as described herein enhance training and testing machine learning models, by providing a realistic simulation of GNSS location data including simulated GNSS errors.

Disclosed herein is a method, including inputting real world coordinates of a real world location and a real world time, number and orbit data of GNSS satellites, terrain model data, and atmospheric model data to a first machine learning model to generate a simulated GNSS location and heading based on the real world location and a simulated GNSS error in location and heading in the real world coordinates. The first machine learning model can be trained based on an acquired GNSS location, an acquired GNSS time, an acquired number and orbit data of the GNSS satellites, an acquired GNSS DOP from real world systems, the terrain model data, and the atmospheric model data. Simulated GNSS data including the simulated GNSS location and heading can be generated to perform one or more of training and testing of a simulated vehicle operation system. The simulated vehicle operation system can include a second machine learning system.

The simulated vehicle operation system can determine a trajectory for operating a vehicle based on the simulated GNSS location and heading and simulated sensor data. GNSS time can be a continuous time scale based on atomic clocks included in the GNSS satellites and is synchronized with coordinated universal time (UTC). The simulated vehicle operation system can be transmitted to a vehicle. The vehicle can acquire the GNSS location and heading from a GNSS receiver and can acquire sensor data from sensors included in the vehicle. The GNSS errors can be determined based on determining the real world location by applying the sensor data to map data using non-linear optimization and determining a difference between the real world location and the GNSS location and heading. The map data can include the terrain model and objects including roadways, buildings, and structures. The simulated GNSS location can include latitude and longitude in real world coordinates.

The first machine learning model can be trained by: generating the simulated GNSS data based on the real world location, the GNSS time; the number and orbit data of the GNSS satellites, the GNSS DOP, and GNSS data, determining a loss function based on the simulated GNSS data and the real world location, and back propagating the loss function through the first machine learning model. The GNSS data can include atmospheric models, and a three-dimensional terrain model that includes roadways, buildings, and structures. The first machine learning model can be trained on an ongoing basis. One or more machine learning models can be generated based on GNSS locations from one or more models of GNSS receivers. The vehicle can be operated by controlling vehicle components.

Further disclosed is a computer readable medium, storing program instructions for executing some or all of the above method steps. Further disclosed is a computer programmed for executing some or all of the above method steps, including a computer apparatus, programmed to input real world coordinates of a real world location and a real world time, number and orbit data of GNSS satellites, terrain model data, and atmospheric model data to a first machine learning model to generate a simulated GNSS location and heading based on the real world location and a simulated GNSS error in location and heading in the real world coordinates. The first machine learning model can be trained based on an acquired GNSS location, an acquired GNSS time, an acquired number and orbit data of the GNSS satellites, an acquired GNSS DOP from real world systems, the terrain model data, and the atmospheric model data. Simulated GNSS data including the simulated GNSS location and heading can be generated to perform one or more of training and testing of a simulated vehicle operation system. The simulated vehicle operation system can include a second machine learning system.

The instructions can include further instructions to program the simulated vehicle operation system to determine a trajectory for operating a vehicle based on the simulated GNSS location and heading and simulated sensor data. GNSS time can be a continuous time scale based on atomic clocks included in the GNSS satellites and is synchronized with coordinated universal time (UTC). The simulated vehicle operation system can be transmitted to a vehicle. The vehicle can acquire the GNSS location and heading from a GNSS receiver and can acquire sensor data from sensors included in the vehicle. The GNSS errors can be determined based on determining the real world location by applying the sensor data to map data using non-linear optimization and determining a difference between the real world location and the GNSS location and heading. The map data can include the terrain model and objects including roadways, buildings, and structures. The simulated GNSS location can include latitude and longitude in real world coordinates.

The instructions can include further instructions to train the first machine learning model by: generating the simulated GNSS data based on the real world location, the GNSS time; the number and orbit data of the GNSS satellites, the GNSS DOP, and GNSS data, determining a loss function based on the simulated GNSS data and the real world location, and back propagating the loss function through the first machine learning model. The GNSS data can include atmospheric models, and a three-dimensional terrain model that includes roadways, buildings, and structures. The first machine learning model can be trained on an ongoing basis. One or more machine learning models can be generated based on GNSS locations from one or more models of GNSS receivers. The vehicle can be operated by controlling vehicle components.

FIG. 1 is a diagram of system 100. In this example, system 100 includes a vehicle 110, however, in other examples system 100 could include a robot, a drone, or an object tracking device. In examples where system 100 includes a robot, a drone, or an object tracking device, controllers 112, 113, 114 would be changes to controllers that control robot, drone, or object tracking device components. In examples described herein, system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate vehicle 110 based on data received from the sensors 116 and data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of speed in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to, i.e., via a vehicle communications bus as described further below, more than one computing devices, i.e., controllers or the like included in the vehicle 110 for monitoring and controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in vehicle 110 and receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and control various vehicle 110 components and operations. For example, the computing device 115 may include programming to control vehicle 110 operational behaviors (i.e., physical manifestations of vehicle 110 operation) such as speed, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and other sensors 116 and the geographical coordinates provided by the GPS sensor may be used by the computing device 115 to operate the vehicle 110 autonomously or semi-autonomously, for example.

The vehicle 110 is generally a land-based vehicle 110 capable of autonomous and semi-autonomous operation and having three or more wheels, i.e., a passenger car, light truck, etc. Vehicle 110 includes one or more sensors 116, the V2I interface 111, the computing device 115 and one or more controllers 112, 113, 114. Sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, power applied to controllers 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2I interface 111 and computing device 115, and therefore these features will not be described further to reduce redundancy. A server computer 120 can be used to develop and train software that can be transmitted to a computing device 115 in a vehicle 110.

FIG. 2 is a diagram of traffic scene 200 that includes a vehicle 110 traveling on roadway 202. The roadway includes one or more roadway edges 204 and lane markers 206. Traffic scene 200 includes one or more traffic signs 208, one or more buildings 210 and foliage including one or more trees 212. Traffic scenes 200 can also include structures such as bridges and overpasses, for example. Vehicle 110 includes one or more sensors 216 having fields of view 214. For example, sensors 216 included in vehicle 110 can include a video camera and a lidar sensor. Fields of view 214 are portions of an environment around a vehicle within which a sensor 216 can obtain data. The data acquired by a video camera can be formatted as a video image and data acquired by a lidar sensor can be formatted as a lidar image, for example.

Computing device 115 included in vehicle 110 can acquire video images and lidar images from sensors 216 and input the video images and lidar images to a computer 115 that receives video images and lidar images and outputs vehicle trajectories that can be used to by computing device 115 to operate vehicle 110. A vehicle trajectory describes a vehicle path, typically including locations, headings, and speeds at respective points or predicted points in time, and can be based on polynomial functions that indicate predicted motion of vehicle 110 in traffic scene 200. Computing device 115 can command controllers 112, 113, 114 to actuate vehicle components to cause vehicle 110 to travel along a vehicle trajectory.

One or more vehicle computers 115 can include hardware and/or software to accept as input video images and lidar images to identify and locate objects such as roadway edges 202, lane markers 206, traffic signs 208, buildings 210, and trees 212. Vehicle computers 115 can include machine learning models including deep neural networks to identify and locate objects in an environment around vehicle 110. Deep neural networks include convolutional neural networks that include convolutional layers that input image data and output latent variables to fully connected layers. Fully connected layers input latent variables and output predictions regarding identities and locations of objects in an environment around vehicle 110.

A vehicle computing device 115 can determine a trajectory for operating a vehicle 110 based on output from a machine learning model. In some examples multiple locations can be determined, and a trajectory can then be determined based on the multiple locations. Computing device 115 can operate a vehicle 110 based on a trajectory by directing controllers 112, 113, 114 to actuate vehicle components to cause the vehicle to travel along the trajectory.

Deep neural networks including convolutional neural networks can be trained with training datasets that include thousands or millions of images along with ground truth that indicates the identities and locations of objects included in the thousands or millions of images. Training a deep neural network includes processing images with images in the training dataset many hundreds or thousands of times, each time comparing the resulting predictions with ground truth data to determine a loss function that describes the magnitude of the difference between the resulting predictions and the ground truth. The loss function is applied to the deep neural network using a process called back propagation, where the loss function is fed back though the layers of the deep neural network from back to front to determine updates to weights used to program each layer. Training can continue until the loss function converges to an acceptably small number which indicates that the selected weights are generating results that are converging on the ground truth.

Testing machine learning models can be done in a similar fashion as training machine learning models. A testing dataset that includes images and generated ground truth data regarding object identities and locations from the data input to the photorealistic rendering software determined at the same time as the training dataset. Following training, the test images are input to the trained machine learning model output predictions are compared to the ground truth. Performance of the machine learning model is determined based on how closely the output predictions compare to the ground truth. A machine learning model is determined to output a correct result when the output identity prediction is the same as the ground truth and the output location is within a tolerance value, for example 1% in both x and y pixel coordinates. A machine learning model can be determined to have successfully passed testing when the machine learning model performance, indicated by percentage of correct results, exceeds a user selected threshold, for example 90% correct results.

Training and testing of machine learning models designed for vehicle operation can be performed on a server computer 120 rather than computing device 115 included in vehicle 110. Server computer 120 can include the large amount of memory required to efficiently store and recall the large amount of data included in a training dataset. A server computer 120 can include a software program that repeatedly cycles data through a machine learning model and keeps track of results to determine when training and testing is complete. When training and testing of a machine learning model is complete, the machine learning model can be transmitted to computing device 115 included in vehicle 110 for use.

Traffic scene 200 can also include one or more GNSS satellites 218 that are visible to vehicle 110. A GNSS satellite 218 is “visible” to vehicle 110 when a GNSS receiver included in vehicle 110 can receive a signal from a GNSS satellite 218. A GNSS receiver included in vehicle 110 can receive a signal from a GNSS satellite 218 when the orbit of the GNSS satellite 218 places it in a position to provide line-of-sight access to the GNSS receiver antenna unblocked by structures or foliage, for example. GNSS signals can range from lower L-Band (1164 MHz to 1300 MHz) to upper L-Band (1559 MHz to 1610 MHz). GNSS signals include a carrier signal, digital ranging codes which permit a receiver to determine travel time from satellite to receiver, and navigation data which can include satellite position data, clock bias parameters, and satellite health status data.

A GNSS receiver in a vehicle can receive GNSS signals from multiple visible GNSS satellites 218 and process the received GNSS signals to determine a location of the GNSS receiver in x and y coordinates. The x and y coordinates are indicated as latitude and longitude in real world coordinates. By tracking multiple x and y coordinates at multiple time steps and assuming that vehicle motion is limited to directions parallel to vehicle wheels, vehicle orientation in rotational coordinates in yaw in the x and y axes can be determined. Combining x and y location coordinates with yaw rotation coordinates can yield a three degree of freedom pose for a vehicle, where pose includes both location and orientation in a plane parallel to a roadway. Yaw rotation coordinates are referred to as either heading or orientation herein.

GNSS location data can be used by computer 115 to locate vehicle 110 with respect to mapping data. In examples, vehicle trajectories determined based on predicted object data as discussed above can be combined with vehicle locations on a map by placing the start of the vehicle trajectory at the map location determined based on GNSS data. Even in best case scenarios, GNSS location data cannot be used alone to locate a vehicle trajectory on a map because, as discussed above, GNSS errors can be too great. Vehicle operation can benefit from locating a vehicle 110 on a roadway with an accuracy of less than one meter. In some examples, for example parking or wireless electrical charging, vehicle location accuracy of less than 10 centimeters can be desired.

An initial estimate of vehicle location on a roadway based on GNSS location data can be obtained from a GNSS receiver included in a vehicle 110. Sensor data can be combined with HD map data by locating features, as described above, in both sensor data and HD map data and then finding a best match between the sensor data features and the HD map data features. Sensor data can include video images or lidar images or both. The vehicle location with respect to the HD map data can be used to enhance the initial vehicle location estimate from GNSS location data to achieve accuracy of one meter or better.

Techniques for combining features determined for both sensor data and HD map data include non-linear optimization. Combining features for sensors and HD map data can also be referred to as localization. GNSS errors can be determined by determining a real world location by applying sensor data to map data using non-linear optimization to determine a difference between a real world location and a GNSS location. Examples of non-linear optimization include the iterative closest point (ICP) algorithm. The ICP algorithm takes as input two sets of points, X={x₁, . . . , xₙ} and P={p₁, . . . , pₙ}, where X includes feature points from sensor data and P includes feature points from HD map data. The ICP algorithm determines a translation/and a rotation R that minimizes the sum of the squared error according to the equation:

$$E ( R , t ) = \frac{1}{{N}_{p}} {\sum }_{i = 1}^{{N}_{p}} {‖ {x}_{i} - {R}_{{p}_{i}} - t ‖}^{2} \qquad ( 1 )$$

Where x; and p; are corresponding points from X and P. E (R, t) can be minimized by iterating starting by projecting the sensor data points onto the HD map data assuming the sensor is located at the GNSS location and moving the starting point in a direction that reduces the sum of squared error until the algorithm converges on a minimum error.

Algorithms for performing ICP include iterative closest point (ICP) and pose graph optimization (PGO-ICP). ICP is described in “Introduction to Mobile Robotics-Iterative Closest Point Algorithm,” Wolfram Burgard, Cyrill Stachniss, Maren Bennewitz, Kai Arras, which can be found at website https://cs.gmu.edu/˜kosecka/cs685/cs685-icp.pdf as of the filing date of this application. PGO-ICP is described in “A Tutorial on Graph-Based SLAM” by Giorgio Grisetti, Rainer Kummerle, Cyrill Stachniss, Wolfram Burgard, which can be found at website http://www2.informatik.uni-freiburg.de/˜stachnis/pdf/grisetti 10titsmag.pdf as of the filing date of this application. These algorithms can be used to estimate GNSS error based on sensor data acquired by vehicles 110 as described below.

As discussed above, GNSS error can be based on the number and locations of visible GNSS satellites 218. The number of visible GNSS satellites 218 is a function of GNSS satellite orbit data, the real world location of the GNSS receiver, the real world time, atmospheric conditions and possible intervening terrain, e.g., mountains or buildings, for example. These factors can be combined to determine a dilution of precision (DOP) value. DOP can be determined by a GNSS receiver based on the vector locations of the visible GNSS satellites with respect to the receiver and a correlation matrix for noise in the GNSS satellite signals measured by the receiver. The receiver can output a DOP value according to Table 1.

TABLE 1
DOP Values

| DOP | | |
|---|---|---|
| Value | Rating | Description |
| <1 | Ideal | Highest accuracy |
| 1-2 | Excellent | Acceptable accuracy |
| 2-5 | Good | Minimum acceptable accuracy |
| 5-10 | Moderate | Accuracy needs improvement |
| 10-20 | Fair | Low confidence accuracy |
| >20 | Poor | Measurements should be discarded |

Determination of DOP values is described in Isik, Oguz Kagan, Juhyeon Hong, Ivan Petrunin, and Antonios Tsourdos, “Integrity Analysis for GPS-Based Navigation of UAVs in Urban Environment,” Robotics 9, no. 3:66, August 2020. DOP values can used to determine a confidence value for GNSS accuracy estimates. When the DOP value corresponding to a GNSS error estimate is equal to or less than a user-selected threshold, for example four, the error estimate can be used. When the DOP value is greater than a user-selected threshold, the error estimate can be discarded.

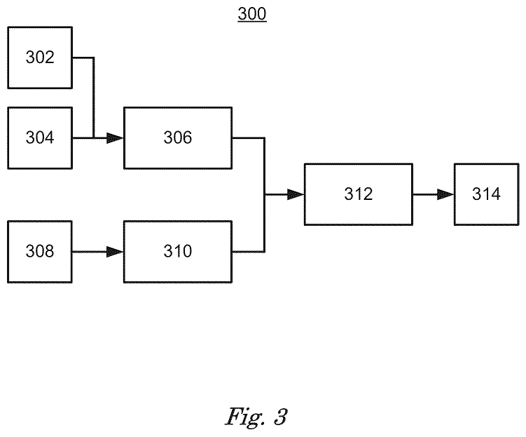

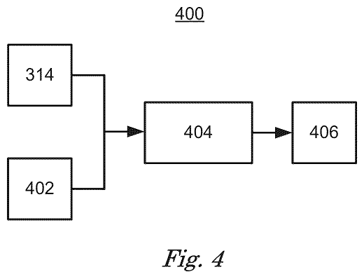

GNSS covariance is another measure of GNSS accuracy. GNSS receivers can output a GNSS covariance matrix along with a location and DOP. A GNSS covariance matrix includes an estimate of x-direction variance vx, an estimate of y-direction variance vy and covariances in x and y, Vxy and Vyx. Variance is an estimate of the degree to which location measurement can be expected to vary from the mean and covariance is a measure of the strength of correlation between the x and y variances. GNSS covariance can be used to determine a confidence measure of an estimated GNSS error determined by techniques for estimating GNSS errors as described in relation to FIGS. 3 and 4, below. An estimated GNSS error can be compared to a measured mean GNSS error for the receiver to determine how the GNSS error compares to the expected variance.

FIG. 3 is a diagram of a GNSS error estimation system 300. GNSS error estimation system 300 is a software program that can execute on a server computer 120. Multiple vehicles 110 can be connected to server computer 120 via network 130. Acquisition software executing on computing devices 115 included in vehicles 110 can be programmed to acquire GNSS data 304 and sensor data 308, including video images and, if the vehicle 110 is so equipped, lidar images, and transmit the GNSS data 304 sensor data 308 to server computer 120. The acquisition software can acquire GNSS data 304 including acquired GNSS locations, acquired GNSS DOP, and GNSS covariance including acquired GNSS errors, acquired GNSS time from a GNAA receiver included in vehicle 110 and acquired number and locations of GNSS satellites from a publicly available database. The acquisition software can also acquire a number and locations of GNSS satellites from publicly available databases as will be described below. The sensor data 308 and GNSS data 304 can be acquired periodically at time intervals or distance intervals as a vehicle 110 travels through the real world. The GNSS error estimation system can determine GNSS errors by processing acquired sensor data 308 as described below based on map data acquired from publicly available sources.

By acquiring multiple sets of sensor data 308 and GNSS data 304 from multiple vehicles 110 at multiple real world locations at multiple times GNSS error estimation system 300 can estimate GNSS errors for multiple real world locations and times as vehicles 110 travel in the real world. GNSS error estimation system 300 can receive sensor data 308 and GNSS data 304 and combine it with HD map data 302 to estimate GNSS errors. HD map data 302 can include a portion of the HD map data 302 surrounding a GNSS location included in GNSS data 304. The portion of HD map data 302 can be sized to include fields of view 214 of sensor data 304. Acquiring GNSS data 304, sensor data 302, and sizing HD map data 302, can be done by a data acquisition software program executing on server computer 120 without requiring human intervention. When a vehicle 110 has sensor data 302 and GNSS data 304 to transmit to GNSS error estimation system 300, the data acquisition software program can recall HD map data 302 from memory included in server computer 120 or acquire HD map data 302 from a map data source on the Internet, for example GOOGLE™ maps or the like. The acquisition software program can also receive the output estimated GNSS error and store it in a training dataset 314 indexed by GNSS location and time.

GNSS error estimation system 300 includes map feature detector 306. Map feature detector 306 receives GNSS data 304 and HD map data 302 for a region that includes the GNSS location and detects features in the HD map data 302 as described above using a feature detector such as FAST to indicate locations in HD map data 302. Feature detectors such as FAST can detect features such as edges of roadway edges 204 and traffic lane markers 206. In parallel with map feature detector 306, image feature detector 310 can detect features in sensor data 308, including video images and lidar image.

Image feature detector 310 can project features detected in image data onto real world coordinates using projective geometry to convert x, y pixel locations in video image data to real world locations relative to vehicle 110 location. Projective geometry can use camera intrinsic data, including focal distance, sensor size, and lens magnification and camera extrinsic data such as camera height above a roadway 202 and camera orientation to convert pixel x, y locations to real world coordinates with respect to vehicle 110 location. Features included in lidar image data can be directly projected into real world coordinates by image feature detector 310 with respect to vehicle 110 location because lidar images include range data with respect to the lidar sensor.

Features output by map feature detector 306 can be combined with features output by image feature detector 310 by non-linear optimizer/localizer 312. Non-linear optimizer/localizer 312 uses a non-linear optimization algorithm as described above in relation to FIG. 2 to determine a best fit between map feature points output by map feature detector 306 and image feature points output by image feature detector 310. Because the image feature points include a location of the sensor, and the sensor orientation and location with respect to the vehicle 110 are determined at manufacturing time, locating the image feature points with respect to the map feature points can determine the real world location of the vehicle 110 at the time the video images and lidar images were acquired. The real world location of vehicle 110 determined based on image data can be compared to the acquired GNSS location to determine the GNSS error for the real world location at the real world time the GNSS data were acquired. The GNSS error estimation system 300 can store the output estimated GNSS error in a training dataset 314 indexed by real world location and real world time.

In addition to real world sensor data 308 and GNSS data 304, GNSS error estimation system 300 can estimate GNSS errors based on simulated data. GNSS error estimation system 300 can input a time and location from a simulation. The GNSS error estimation system 300 can obtain satellite positions from publicly available databases of satellite positions such as the In-The-Sky.org website as of the filing date of this application. The In-The-Sky.org database can be accessed to determine the locations in the sky of all potentially visible GNSS satellites from a given location at a given time. The locations of all potentially visible satellites can be combined with terrain data from publicly available terrain mapping data available from mapping sources such as GOOGLE maps to determine whether any of the potentially visible satellites are blocked by terrain or buildings. Terrain data can also be used to estimate multi-path error caused by reflections of GNSS signals by terrain and buildings that contribute to GNSS error.

Atmospheric conditions that can affect GNSS signals can be obtained from publicly available databases such as the Global Atmospheric Models available from the Geophysical Fluid Dynamics Laboratory (GFDL) of the National Oceanic and Atmospheric Administration (NOAA) at the gfdl.noaa.gov/atmospheric-model website as of the filing date of this application. The data regarding visible satellites from the In-The-Sky database along with terrain data from GOOGLE maps and atmospheric conditions from the GFDL can be used to estimate GNSS DOP and a covariance matrix that can be combined to estimate GNSS error for a given location and time. The estimated GNSS error can be entered into training dataset 314 indexed by location and time.

FIG. 4 is a diagram of a machine learning training system 400. Machine learning training system 400 can use GNSS errors included in the training dataset 314 to train a machine learning model 404 to generate predictions of estimated GNSS error 406 for locations and times not included in the training dataset 314. In this fashion, a first trained machine learning model 404 can be used to generate simulated GNSS data to be used to train a second machine learning model based on estimated GNSS errors 406 for simulated locations and times that are not included in real world datasets. Machine learning system 400 can be executed on server computer 120 by a training software program that sequences through a training dataset 314, accesses satellite visibility websites, terrain mapping websites and atmospheric condition websites to estimate GNSS conditions 402 and input them to machine learning model 404 along with locations and times from the training dataset 314.

Machine learning model 404 can be a neural network (NN) that includes multiple layers of fully connected neurons that can compute linear or non-linear functions based on the input data. In examples where machine learning model 404 receives image data, for example map data, a convolutional neural network (CNN) that includes multiple convolutional layers followed by multiple fully connected layers can be employed. In examples where machine learning model 404 receives time series data, for example multiple real world locations included in a trajectory that describes the motion of a vehicle over a short time sequence such as 10 to 30 seconds, a recurrent neural network (RNN) or a long term-short memory (LTSM) machine learning model can be employed.

The above different types of neural networks have in common that they are trained by inputting a measured location and time from training dataset 314 along with GNSS conditions 402 including GNSS DOP, number and orbit data of GNSS satellites, terrain model data and atmospheric model data corresponding to the location and time to the machine learning model 404 multiple times. The machine learning model 404 determines a simulated GNSS error 406 in location and heading. The simulated GNSS error 406 can be combined with the input measured location to yield a simulated GNSS location and heading. The machine learning model 404 can also output GNSS covariance and GNSS DOP. The training software program compares the simulated GNSS error 406 with the measured GNSS error from the training dataset to determine a loss function that indicates a difference between the simulated GNSS error 406 and the measured GNSS error. The loss function can be back propagated through the layers of the machine learning model 404 to determine weights that program the functions included in each layer. Back propagating is a process that adjusts the weights included in each layer of a neural network starting at the layer closest to the output and adjusting weights in each layer from back to front to account for a portion of the loss function.

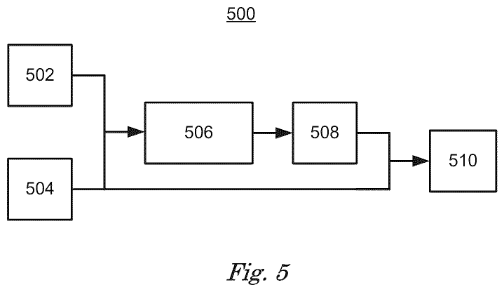

The loss function can be differentiable, for example, to permit the training software program to determine which direction to change the weights at the layers of the machine learning model 404 to permit the loss function to converge on a minimal value based on determining predicted GNSS errors for the locations and times included in the training dataset. The weights that correspond to the minimal loss function value are the weights included in the trained machine learning model. The weights included in the trained machine learning model can be determined by processing thousands or millions of input locations thousands of times each to determine the final values of weights included in the trained machine learning model to converge on minimal loss function values. Following training, the trained machine learning model 404 can be output to a simulation training and test system 500 as illustrated in FIG. 5.

The machine learning model 404 can be trained on a periodic and/or ongoing basis. As new locations, times, map data 302, sensor data 304, and GNSS data 308 are acquired by GNSS error estimation system 300, and new GNSS error estimates are entered into the training database 314, the training software program can update the training. The updated machine learning model 404 can be output to the simulation training and test system 500 to replace a previous version of the machine learning model 404.

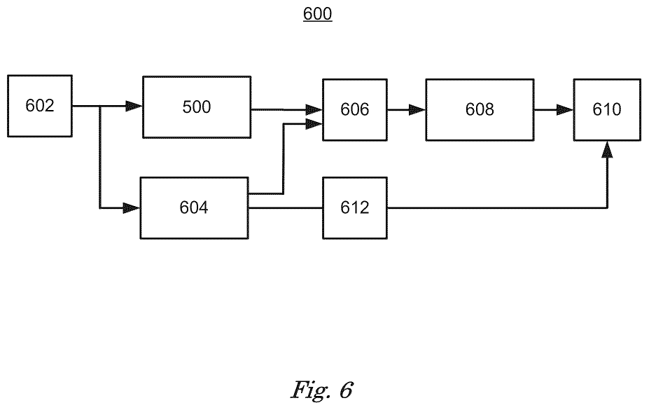

FIG. 5 is a diagram of a GNSS simulation system 500. GNSS simulation system 500 generates simulated GNSS data 510 including simulated GNSS locations and GNSS covariance data that indicates GNSS error for training and testing vehicle operation systems 600 as illustrated in FIG. 6. GNSS simulation system 500 executes as part of a vehicle operation training and test system 600 under control of a vehicle operation training and test software program as will be described in relation to FIG. 6, below. GNSS simulation system 500 includes a trained machine learning model 506 that receives as input time and location data 504 and GNSS data 502 including satellite orbit data, atmospheric models, and terrain data corresponding to the time and location data 504. The satellite orbit data, atmospheric models, and terrain data are generated from publicly available databases as described above in relation to FIG. 4.

Time and location data 504 and GNSS data 502 are received by a trained machine learning model 506, trained as described above in relation to FIG. 4. As described above, the trained machine learning model 506 outputs predictions 508 including GNSS error, GNSS covariance, and the number of visible satellites. The output predictions 508 are combined with time and location data 504 to form GNSS simulation output 510 which includes a simulated GNSS location, GNSS covariance, and GNSS error.

FIG. 6 is a diagram of a vehicle operation training and test system 600. Vehicle operation training and test system 600 can execute on a server computer 120 under control of a vehicle operation training and test software program. The vehicle operation training and test software program can include a list of vehicle scenarios 602. Vehicle scenarios 602 include a geographic location, which can be specified as x and y coordinates in longitude and latitude, for example, and an orientation, which is an angle with respect to the x and y axes that describe a vehicle location. The vehicle scenario can include a type of vehicle 110 which specifies the types of sensors 116 included in the vehicle 110, where the type of vehicle 110 can include make, model, and year. The types of sensors 116 can include numbers and locations of video cameras and lidar sensors and includes intrinsic and extrinsic parameters of the sensors 116 as described above. The vehicle scenario also includes specification of the GNSS receiver included in vehicle 110, which can includes the make and model of the GNSS receiver. The vehicle scenario 602 includes a time, expressed in GNSS time, which is a continuous time scale that is based on atomic clocks included in GNSS satellites. GNSS time can be synchronized with Coordinated Universal Time (UTC) by adding leap seconds to UTC time, currently about 18 seconds. A vehicle scenario 602 can also specify a season (spring, summer, fall, or winter), weather conditions (rain, snow, fog, etc.) and traffic, e.g., number and locations of other vehicles to be rendered.

Vehicle operation training and test software can be initialized by selecting training, testing, or both, selecting a vehicle 110 type and selecting the number and distributions of locations, times, seasons, weather and traffic conditions. The vehicle operation training and test software can then cycle or iterate through the specified vehicle scenarios 602. During training the vehicle operation training and test software can execute vehicle operation machine learning model 608 multiple times with the same input data 606 to determine weights for the vehicle operation machine learning model by minimizing a loss function as described above in relation to FIG. 4 to train the vehicle operation machine learning model 608. During testing, the vehicle operation training and test software can execute the vehicle operation machine learning model 608 on vehicle scenario 602 data that was not seen during training to determine the performance of the trained vehicle operation machine learning model 608.

Execution of the vehicle operation training and test system 600 begins with the vehicle operation training and test system 600 inputting a vehicle location and time from a vehicle scenario 602 to a GNSS simulation system 500 as described above in relation to FIG. 5. The GNSS simulation system 500 receives a vehicle location and time and outputs GNSS simulation data 510 which includes a simulated GNSS location, GNSS covariance, and GNSS error to sensor data 606.

In parallel with GNSS simulation system 500, rendering engine 604 receives a vehicle scenario 602. Rendering engine 604 can include a photorealistic rendering engine such as Unreal Engine as described above. Rendering engine 604 formats data from vehicle scenario 602 for input to the photorealistic rendering engine including downloading map data from the Internet as described above in relation to FIG. 4 to permit photorealistic rendering engine to render backgrounds that look like real world backgrounds from the specified locations, including foliage, buildings, and structures such as bridges and overpasses, etc. Rendering engine 604 can also include a library of vehicle data to permit a selection of vehicle makes, models, colors, etc. to be rendered at specified locations in the output image. Output from rendering engine 604 is an image received by sensor data 606 rendered as if it were acquired by a real world vehicle sensor viewing a real world scene from the specified location and orientation. The image output by rendering engine 604 can either be a video image or a lidar image or both. Rendering engine 604 can also output object ground truth 612. Because vehicle scenario 602 specifies the locations for a vehicle 110 and other objects in the rendered image, object ground truth 612 includes the real world locations of vehicle 110 and the other objects such as roadways, vehicles, buildings and structures. This data can be compared to the predictions 610 output by the vehicle operation machine learning model 608 to determine a loss function for training or a performance for testing.

The sensor data 606 output from GNSS simulation system 500 and rendering engine 604, including GNSS simulation data 510 and one or more rendered images, is received by vehicle operation machine learning model 608. Vehicle operation machine learning model 608 is trained and tested on server computer 120 based on simulated GNSS location and heading and simulated image data. Training and testing a vehicle operation machine learning model 608 using simulated image data and simulated GNSS location and heading is hugely more efficient in terms of computing resources than attempting to train and test a vehicle operation machine learning model 608 executing on a computing device 115 included in a vehicle 110 using data from sensors 116 also included in vehicle 110. Even if simulated data were used to train and test a vehicle operation machine learning model 608 included in a vehicle, the data transfers to and from a training dataset to and from the vehicle 110 computing device 115 would likely be prohibitively inefficient and/or large.

Training and testing a vehicle operation machine learning model using simulated GNSS location and heading based on simulated GNSS errors enhances vehicle operation machine learning model training and testing by making each cycle of training or testing accurately depict the types of GNSS errors that would be encountered in real world operation of a vehicle operation machine learning model. Accurately depicting real world GNSS location and heading based on simulated GNSS location and heading permits training and testing vehicle operation machine learning models to be trained to perform well under real world conditions using fewer computing resources including less compute time than training and testing a vehicle operation machine learning model without depicting real world GNSS errors.

A vehicle operation machine learning model 608 that was trained without depicting real world GNSS errors could experience higher than expected variance in results when introduced into a vehicle 110 operating in the real world at a location with higher than average GNSS errors. This could reduce performance of the vehicle operation machine learning model 608 and possibly warrant retraining for locations that experience higher than normal GNSS errors. By identifying these locations at training and test time, techniques for simulating GNSS location and heading can prevent poor performance and potential retraining of vehicle operation machine learning models 608 which can require additional computing resources and computer time.

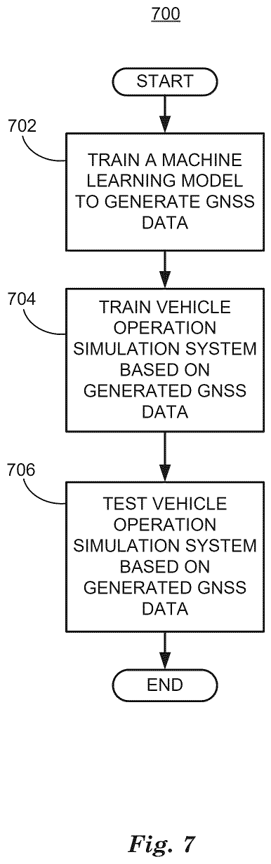

FIG. 7 is a flowchart diagram of a process 700 for training a simulated vehicle operation system 500 to operate a vehicle 110 based on simulated GNSS location and heading. Process 700 can be implemented as hardware and/or software executing on a server computer 120 to train the simulated vehicle operation system 500. The trained vehicle operation system 500 can be transmitted to a computing device 115 included in a vehicle 110 to operate the vehicle. Process 700 includes multiple blocks that can be executed in the illustrated order. Process 700 could alternatively or additionally include fewer blocks and can include the blocks executed in different orders.

Process 700 begins at block 702, where a machine learning model 400 is trained on a server computer 120 to generate simulated GNSS location and heading based on GNSS data and sensor data acquired by vehicles 110 operating in the real world as described above in relation to FIGS. 2-4.

At block 704 the trained machine learning system 400 is used to generate simulated GNSS data 502 and, along with simulated sensor data 504 is input to a vehicle operation system 500 including a vehicle operation machine learning model 506 to train the vehicle operation machine learning model 506.

At block 706, the trained machine learning system 400 is used to generate simulated GNSS data 502 and, along with simulated sensor data 504 is input to a vehicle operation system 500 including a vehicle operation machine learning model 506 to test the vehicle operation machine learning model 506. Following block 706, process 700 ends.

Any action taken by a vehicle or user of the vehicle should comply with all rules and regulations specific to the location and operation of the vehicle (e.g., Federal, state, country, city, etc.). More so, any operations disclosed herein are for illustrative purposes only. Certain operations may be modified and omitted depending on the context, situation, and applicable rules and regulations. Further, regardless of the operations or determinations, users should use good judgement and common sense when operating the vehicle. That is, all operations, whether standard or “enhanced,” should be followed only when proper to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a first computer that includes a processor and a memory, the memory including instructions executable by the processor to:
input real world coordinates of a real world location and a real world time, number and orbit data of GNSS satellites, terrain model data, and atmospheric model data to a first machine learning model to generate a simulated GNSS location and heading based on the real world location and a simulated GNSS error in location and heading in the real world coordinates;
wherein the first machine learning model is trained based on an acquired GNSS location, an acquired GNSS time, an acquired number and orbit data of the GNSS satellites, an acquired GNSS DOP from real world systems, the terrain model data, and the atmospheric model data; and
generate simulated GNSS data including the simulated GNSS location and heading to perform one or more of training and testing of a simulated vehicle operation system.

2. The system of claim 1, wherein the simulated vehicle operation system includes a second machine learning system.

3. The system of claim 1, wherein the simulated vehicle operation system determines a trajectory for operating a vehicle based on the simulated GNSS location and heading and simulated sensor data.

4. The system of claim 1, wherein GNSS time is a continuous time scale based on atomic clocks included in the GNSS satellites and is synchronized with coordinated universal time (UTC).

5. The system of claim 1, wherein the simulated vehicle operation system is transmitted to a vehicle.

6. The system of claim 5, wherein the vehicle acquires the GNSS location and heading from a GNSS receiver and acquires sensor data from sensors included in the vehicle.

7. The system of claim 6, wherein the GNSS errors are determined based on determining the real world location by applying the sensor data to map data using non-linear optimization and determining a difference between the real world location and the GNSS location and heading.

8. The system of claim 7, wherein the map data includes the terrain model and objects including roadways, buildings, and structures.

9. The system of claim 1, wherein the simulated GNSS location includes latitude and longitude in real world coordinates.

10. The system of claim 1, the instructions including further instructions to train the first machine learning model by:
generating the simulated GNSS data based on the real world location, the GNSS time; the number and orbit data of the GNSS satellites, the GNSS DOP, and GNSS data;
determining a loss function based on the simulated GNSS data and the real world location; and
back propagating the loss function through the first machine learning model.

11. The system of claim 10, wherein the GNSS data includes atmospheric models, and a three-dimensional terrain model that includes roadways, buildings, and structures.

12. The system of claim 10, wherein the first machine learning model is trained on an ongoing basis.

13. The system of claim 1, wherein one or more machine learning models are generated based on GNSS locations from one or more models of GNSS receivers.

14. A method, comprising:
inputting real world coordinates of a first location and a real world time, number and orbit data of GNSS satellites, terrain model data, and atmospheric model data to a first machine learning model to generate a simulated GNSS location and heading based on the first location and a simulated GNSS error in location and heading in the real world coordinates;
wherein the first machine learning model is trained based on an acquired GNSS location, an acquired GNSS time, an acquired number and orbit data of the GNSS satellites, an acquired GNSS DOP from real world systems, the terrain model data, and the atmospheric model data; and
generating the simulated GNSS location and heading to perform one or more of training and testing of a simulated vehicle operation system.

15. The method of claim 14, wherein the simulated vehicle operation system includes a second machine learning system.

16. The method of claim 14, wherein the simulated vehicle operation system determines a trajectory for operating a vehicle based on the simulated GNSS location and heading and simulated sensor data.

17. The method of claim 14, wherein GNSS time is a continuous time scale based on atomic clocks included in the GNSS satellites and is synchronized with coordinated universal time (UTC).

18. The method of claim 14, wherein the simulated vehicle operation system is transmitted to a vehicle.

19. The method of claim 18, wherein the vehicle acquires the GNSS location and heading from a GNSS receiver and acquires sensor data from sensors included in the vehicle.

20. The method of claim 19, wherein the GNSS errors are determined based on determining a real world location by applying the sensor data to map data using non-linear optimization and determining a difference between the real world location and the GNSS location and heading.
